(19) United States
(12) Patent Application Publication
(10) Pub. No.: US 2007/0275124 A1
(43) Pub. Date: Nov. 29, 2007

(54) Beverage

(76) Inventor: Anatoly Anatolyevich Kutyev, Moscow (RU)

Correspondence Address: PATENTTM.US, P. O. BOX 82788, PORTLAND, OR, 97282-0788, US

(21) Appl. No.: 11/574,971

(22) PCT Filed: Sep. 5, 2005
(86) PCT No.: PCT/RU05/00449

§ 371 Date: Mar. 8, 2007

(30) Foreign Application Priority Data
Sep. 10, 2004 (RU) 2004127001

(51) Int. Cl. A23L 2/54; A23L 2/02; C12C 12/00; A23L 2/38

(52) U.S. Cl. 426/67; 426/319; 426/590

(57) ABSTRACT

The invention relates to the food industry, in particular to producing beverages exhibiting laughing properties. The inventive alcohol-free beverage comprises a liquid base and nitrogen oxide which is used in a quantity equal to or less than 40 g rer 1 litre of liquid base. The gas is introduced at a temperature ranging from 1 to 25° C. and a pressure of 1-21 atm according to the beverage production process. Said invention makes it possible to improve the final product guilty by preserving the beverage taste and flavour during a storage period.

The present invention relates to the food industry. in particular to beverages exhibiting “laughing” properties.

An alcohol-free beverage is known in the art that comprises a noble gas, e.g., argon, which content is at least 3% by volume (see, RU 2218055 C2, A 23 L2/54, publ. 10.12.2003).

A disadvantage of the said beverage is its high energy content and complexity of production.

The closest analogous solution is a beverage that comprises nitrous oxide and a liquid base which is commonly water (see, RU 92010834 A, publ. 27.03.1995).

Its disadvantage is that the said beverage is used only for the purpose of maintaining a good mood, i.e., ensuring an “inebriate and laughing” effect.

The technical effect is to improve quality of the finished product due to preservation of its flavor and aromatic properties until its expiration date. The basic task is to create a beverage comprising a liquid base with nitrous oxide dissolved therein, which is intended to achieve an inebriate and laughing effect in a consumer.

The stated technical effect can be achieved due to the fact that the inventive beverage comprises nitrous oxide and a liquid base, said nitrous oxide being introduced in an amount not more than 40 grams per 1 liter of the said liquid base at a temperature ranging from 1° C. to 25° C. and a pressure ranging from 1 atm to 21 atm.

As a liquid base the inventive beverage comprises a mineral or drinking water, or a juice, or a nectar, as well as a soft drink or a low-alcohol beverage, or beer, or an alcoholic beverage.

Further, the inventive beverage may be additionally saturated with oxygen or carbon dioxide or their mixture, as well as sugar or a sweetener, vitamins, microelements may be added also. For the latter, a mixture of vitamins A, B₁, B₂, B₆, B₁₂, D, E, folic acid, calcium-O-pantothenate (vitamin B₃), nicotinic acid (vitamin PP), biotin, ascorbic acid or sodium ascorbinate may be used in the respective amounts (in grams): 2.0-8.0; 0.02-0.06; 30.0-40.0; 4.0-10.0; 4.0-8.0; 4.0-10.0; 0.01-0.03; 1.0-4.0; 25.0-35.0; 60.0-70.0; 0.5-1.0 and 300.0-400.0.

The inventive beverage does not exhibit side effects common to alcoholic beverages based on ethyl alcohols. Also, the inventive beverage is technologically efficient, environment-friendly since its production causes no harmful emissions to the atmosphere, as in the case of alcoholic beverage production. The finished beverage has special organoleptic properties, tasty and safe for the human vital organs (liver, stomach, vascular system, etc.).

As to its nature, nitrous oxide is a colorless has having a slight pleasant odor and sweetish taste; it is heavier than air (its relative density is 1.527), soluble in water in proportion of 1:2. It liquefies into a colorless liquid at 0° C. and pressure of 30 atm.

According to this invention, a beverage based on nitrous oxide comprises a liquid base saturated with nitrous oxide, the latter being introduced in an amount not more than 40 grams per 1 liter of the liquid base, the gas being introduced at a temperature ranging from 1° C. to 25° C. [symbol] C and a pressure ranging from 1 atm to 21 atm.

The liquid base is prepared according to a standard technology. A mineral or drinking water or a juice may be used as a liquid base. If for preparation of a liquid base drinking water is used, it is purified, clarified, disinfected and cleaned from iron. Disinfection is carried out by passing though filters, chlorinating, treating with ozone, treating with silver ions, treating with bactericidal radiation or ultrasonic waves, and water is softened to the required salt content. If fruit juices are used as the liquid base (orange, lemon, apple, grapefruit, mango, etc. or a mixture thereof), they are fed to a blending tank after filtration. If juice concentrates are used, before filtration they are reduced to the initial juice concentration. Then, nitrous oxide is introduced into the liquid base in an amount not more than 40 grams per 1 liter of the liquid base at a temperature ranging from 1° C. to 25° C. [symbol] C and a pressure ranging from 1 atm to 21 atm.

Before introducing nitrous oxide, sugar may be added to the liquid base in the form of a sugar syrup or a sweetener for which aspartame, stevioside, sweetly, riosan, etc. may be used. Also vitamins may be added, such as vitamin B or C, and then, while stirring the obtained solution, microelements, such as iron, calcium, magnesium, etc., are introduced successively. The liquid base is additionally supplemented with medicinal preparations in the form of a mixture of vitamins A, B₁, B₂, B₆, B₁₂, D, E, folic acid, calcium-O-pantothenate (vitamin B₃), nicotinic acid (vitamin PP), biotin, ascorbic acid or sodium ascorbinate in the respective amounts (in grams): 2.0-8.0; 0.02-0.06; 30.0-40.0; 4.0-10.0; 4.0-8.0; 4.0-10.0; 0.01-0.03; 1.0-4.0; 25.0-35.0; 60.0-70.0; 0.5-1.0 and 300.0-400.0.

The obtained blend is thoroughly mixed for 10-14 minutes, aged, filtered, and its volume is brought to a preset value by adding the liquid base. The obtained beverage may be saturated with carbon dioxide or oxygen or their mixture, and then it is fed to filling equipment.

### EXAMPLE 1

The beverage is made as above, except for the following components are taken per 1 liter of a liquid base:

| | |
|---|---|
| Nitrous oxide, g | 5 |
| Liquid base | the rest. |

### EXAMPLE 2

The beverage is made as in Example 1, with the following component content:

| | |
|---|---|
| Nitrous oxide, g | 4 |
| Vitamin B₁₂, mg | 5 |
| Mineral water, medium salt load | the rest. |

### EXAMPLE 3

The beverage is made as in Example 1, with the following component content:

| | |
|---|---|
| Nitrous oxide, g | 8 |
| Vitamin C, mg | 150 |
| Iron, mg | 1.1 |
| Drinking water | the rest. |

### EXAMPLE 4

The beverage is made as in Example 1, with the following component content:

| | |
|---|---|
| Nitrous oxide, g | 7 |
| Medicinal preparation, g | 430.53 |
| Zinc, mg | 0.5 |
| Orange juice | the rest |

Where the said medicinal preparation is a mixture comprising Vitamin A—2.0 g; Vitamin B₁—0.02 g, Vitamin B₂—30.0 g, Vitamin B₆—4.0 g, Vitamin B₁₂—4.0 g, Vitamin D—4.0 g, Vitamin E—0.01 g; folic acid—1.0 g; calcium-D-pantothenate (Vitamin B₃)—25.0 g; nicotinic acid (Vitamin PP)—60.0 g; biotin—0.5 g; and ascorbic acid or sodium ascorbinate—300 g.

### EXAMPLE 5

The beverage is made as in Example 1, with the following component content:

| | |
|---|---|
| Nitrous oxide, g | 7 |
| Medicinal preparation, g | 586.09 |
| Zinc, mg | 0.5 |
| Orange juice | the rest |

Where the said medicinal preparation is a mixture comprising Vitamin A—8.0 g, Vitamin B₁—0.06 g; Vitamin B₂—40.0 g; Vitamin B₆—10.0 g; Vitamin B₁₂—8.0 g; Vitamin D—10 g; Vitamin E—0.03 g; folic acid—4.0 g; calcium-D-pantothenate (Vitamin B₃)—35.5 g; nicotinic acid (Vitamin PP)—70.0 g; biotin—1.0 g; and ascorbic acid or sodium ascorbinate—400 g.

The inventive beverage maintains its flavor and aromatic properties for a long time. The storage period is 1-1.5 years as compared to the prototype. The inventive beverage made on a liquid base with nitrous oxide dissolved therein exhibits an inebriate and laughing effect.

What is claimed is:

1. A beverage comprising a liquid base and nitrous oxide, wherein nitrous oxide is used in an amount not more than 40 grams per 1 liter of a liquid base, being introduced at a temperature ranging from 1° C. to 25° C. and a pressure ranging from 1 atm to 21 atm.

2. A beverage according to claim 1, wherein a juice or a nectar is taken as a liquid base.

3. A beverage according to claim 1, wherein it comprises a low-alcoholic beverage as the liquid base.

4. A beverage according to Claim 1, wherein it comprises an alcohol-free beverage as the liquid base.

5. A beverage according to claim 1, wherein it comprises an alcoholic beverage as the liquid base.

6. A beverage according to claim 1, wherein it comprises beer as the liquid base.

7. A beverage according to claim 1, wherein it comprises a drinking or mineral water as the liquid base.

8. A beverage according to claim 1, wherein it further comprises sugar or a sweetener.

9. A beverage according to claim 1, wherein it further comprises vitamins.

10. A beverage according to claim 1, wherein it further comprises microelements.

11. A beverage according to claim 1, wherein it further comprises carbon dioxide or oxygen, or their mixture.
